(19) United States
(12) Patent Application Publication
(10) Pub. No.: US 2012/0011691 A1
(43) Pub. Date: Jan. 19, 2012

(54) Button-Fixing Member

(75) Inventor: Kenji Hasegawa, Tokyo (JP)

(73) Assignee: YKK Corporation, Chiyoda-ku, Tokyo (JP)

(21) Appl. No.: 13/257,748

(22) PCT Filed: Apr. 8, 2009
(86) PCT No.: PCT/JP2009/057217

§ 371 Date: Sep. 20, 2011

(51) Int. Cl. B23P 23/04

(52) U.S. Cl. 29/33 R

(57) ABSTRACT

The invention is to provide a button-fixing member including a hollow post, in which the post has a better fabric-piercing property and therefore is less likely to cause a defective piercing, a poor collapse of the post or a poor fixing of a button. The button-fixing member according to the invention includes a base and a post. The post is hollow and includes a triangular pyramid-shaped or quadrangular pyramid-shaped post top and a cylindrical post barrel which extends between the post top and the base. The post top has three or four pyramid-element faces and three or four ridge portions between the pyramid-element faces. The post barrel has slits or grooves which are elongated in the axial direction at the positions circumferentially corresponding to the ridge portions.

### BACKGROUND OF THE INVENTION

The invention relates to a button-fixing member, and more particularly, to a button-fixing member for fixing a button such as a snap button and a decorative button onto a cloth and the like for clothing or bags.

In general, a button-fixing member such as a rivet has been used as a component to fix a button onto a cloth such as clothing. The button-fixing member has a disk-like base, and a post projecting from a center portion of the base, and the button-fixing member is used to fix a button to a cloth by swaging the post which has pierced the cloth. Such a button-fixing member includes one with a solid post (see e.g. Japanese Utility-model Application Laid-open No. S59-128210 etc.) and one with a hollow post (see e.g. Japanese Utility-model Application Laid-open No. S62-164806). The button-fixing member with a hollow post is typically formed by drawing a single metal plate, and has higher buckling deformability and a smaller pressing force required when a button is fixed, compared to a solid post type button-fixing member. On the other hand, a hollow post type button-fixing member is difficult to sharpen the tip of its post compared to the solid type member. Therefore, a hollow type member may have a poor fabric-penetrating (or fabric-piercing) property depending on a variety of cloths, which would lead to a defective piercingness with threads of a cloth entrained by the post. Further, in a hollow post type button-fixing member, the post may be likely to incline with respect to the base at piercing a cloth. Furthermore, with the hollow post type, there is a possibility that the post does not collapse uniformly in the circumferential direction when the post, after piercing a cloth, is swaged by a fixing die (or a part of a button) to fix a button on the cloth, because a force for swaging the post is difficult to be transmitted radially uniformly in the post from its tip to the base (proximal) side. This problem may become more significant when the post inclined with respect to the base at piercing a cloth as mentioned above. This defective collapse (buckling) of the post can make the button easy to come off the cloth, and harm the appearance of a fixed button depending on a variety of buttons, leading to a defective fixing.

[Patent document 1] Japanese Utility-Model Laid-open No. 559-128210
[Patent document 2] Japanese Utility-Model Laid-open No. 562-164806

The invention has been made in view of the above-mentioned problems, and an object of the invention to provide a button-fixing member including a hollow post, in which the post has a better fabric-piercing property and there is less likely to cause a defective piercingness, a poor collapse of the post or a poor fixing of a button.

### SUMMARY OF THE INVENTION

To solve the problemes, according to the invention, there is provided a button-fixing member including a base and a post which projects from the base, for fixing a button to a sheet material (e.g. a cloth or a fabric, and a resin sheet) by swaging the post to lock the button after the post has pierced the sheet material with the projecting end of the post in the lead, wherein the post is hollow and includes a triangular pyramid-shaped or quadrangular pyramid-shaped post top which defines the projecting end and a cylindrical post barrel which extends between the post top and the base; wherein the post top includes three or four pyramid-element faces and three or four ridge portions between the pyramid-element faces; and wherein the post barrel includes dents which are elongated in the axial direction of the post at the positions in the circumferential direction of the post corresponding to the ridge portions.

In the invention, since the post top of the button-fixing member is a triangular pyramid-shaped or a quadrangular pyramid-shaped, the post top can cleave a cloth (the sheet material) intensively at the three or four ridge portions at circumferential intervals of 120 or 90 degrees, the ridge portions corresponding to the ridges of a triangular or quadrangular pyramid. Therefore, as compared to a cone-shaped post top, the post top has a better fabric-piercing property, can reduce fabric-piercing defects even in a fabric with relatively easily entrained threads, and the post is less likely to incline with respect to the base at piercing a cloth.

Further, in the invention, when the post of the button-fixing member is compressed by a die and the like to fix a button to a cloth, a force to compress the post is transmitted from the projecting end of the post through the post top to the post barrel. At this moment, the force is conveyed from the post top to the post barrel via the ridge portions rather than the pyramid-element faces in the top post. This is because the ridge portions can function as a shell frame of the post top. The force via the ridge portions is transmitted, firstly to the regions in the post barrel axially adjacent to the ridge portions. The regions including the dents are less rigid in resistance to axial buckling due to the dents, in which the dents are formed, so the dent including regions at circumferentially 120 or 90 degree intervals are tend to more easily collapse axially and extend radially outward larger than the remaining parts between circumferentially adjacent dents and without dents.

In the invention, the term “dent” includes a through hole such as a slit which penetrates a plate forming the hollow post barrel as well as a recessed portion such as a groove which partially thins the plate. Such a dent including a groove, a slit extends in the axial direction of the post, and can be formed in the form of, for example, a straight line, elongated ellipse or rectangle, a perforated line and the like.

The button-fixing member according to the invention may be formed by drawing a single metal plate. As a metal material, aluminum alloy, brass and the like can be preferably exemplified, but not limited thereto.

In the invention, since the post top of the button-fixing member is a triangular pyramid-shaped or a quadrangular pyramid-shaped, a better fabric-piercing property can be obtained, and there is less likely to cause fabric-piercing defects. Further, since the regions, in which the dents are formed, in the post barrel circumferentially corresponding to the ridge portions of the post top are less rigid in resistance to axial buckling, a force to compress the post, which is transmitted mainly via the ridge portions to the barrel post, is received at the dent including region at circumferentially 120 or 90 degree intervals, and therefore the dent including regions at circumferentially 120 or 90 degree intervals can relatively easily collapse axially and extend radially outward larger. As a result, there is less likely to cause the post to collapse in a circumferentially biased form and bring about a defective fixing of a button.

### BRIEF DESCRIPTION OF THE DRAWINGS

FIG. 1 is a perspective view of a button-fixing member according to an embodiment of the invention.

FIG. 2 is a plane view (a top view) of the button-fixing member of

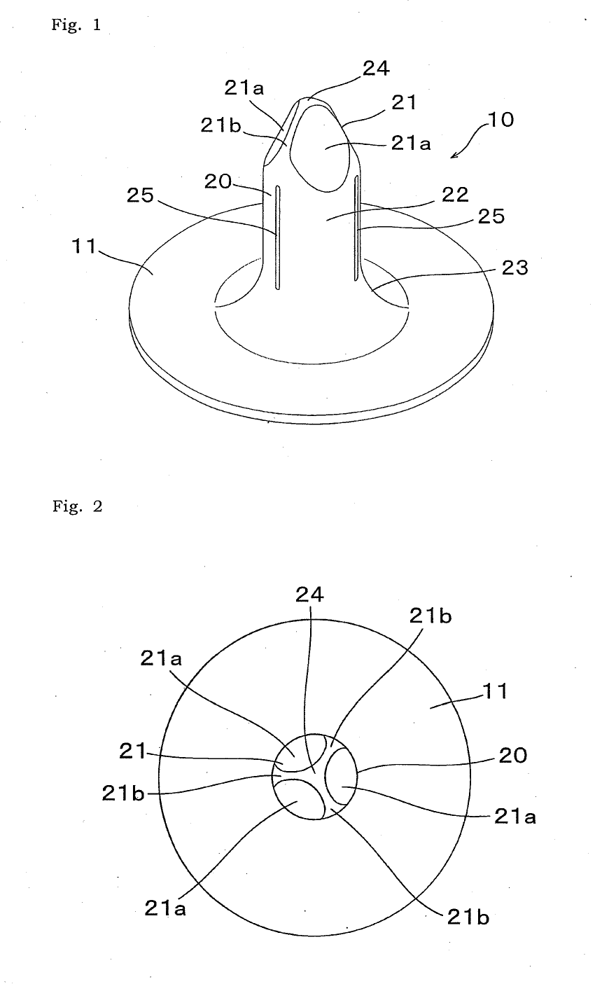

FIG. 1.

FIG. 3 is a longitudinal sectional view of the button-fixing member of FIG. 1.

FIG. 4 is a sectional view taken along line A-A of FIG. 3.

FIG. 5 is a sectional view taken along line B-B of FIG. 3.

FIG. 6 is an explanatory sectional view illustrating a state before swaging the post when a female snap is fixed onto a cloth with the button-fixing member.

FIG. 7 is an explanatory sectional view illustrating a state after swaging the post when a female snap is fixed onto a cloth with the button-fixing member.

FIG. 8 is an explanatory sectional view taken along line C-C of FIG. 7 illustrating the swaged post.

FIG. 9 is a cutaway perspective view of an upper half part of a post of a button-fixing member according to another embodiment of the invention.

FIG. 10 is a sectional view with respect to FIG. 9 as similar to FIG. 4.

FIG. 11 is a cutaway perspective view showing an example of a post barrel with grooves formed.

FIG. 12 is a lateral sectional view of FIG. 11.

### DETAILED DESCRIPTION OF THE INVENTION

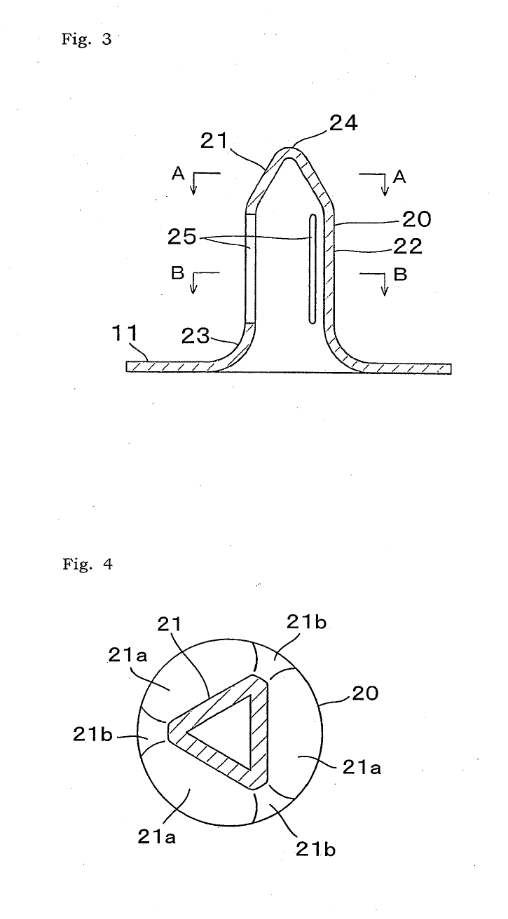

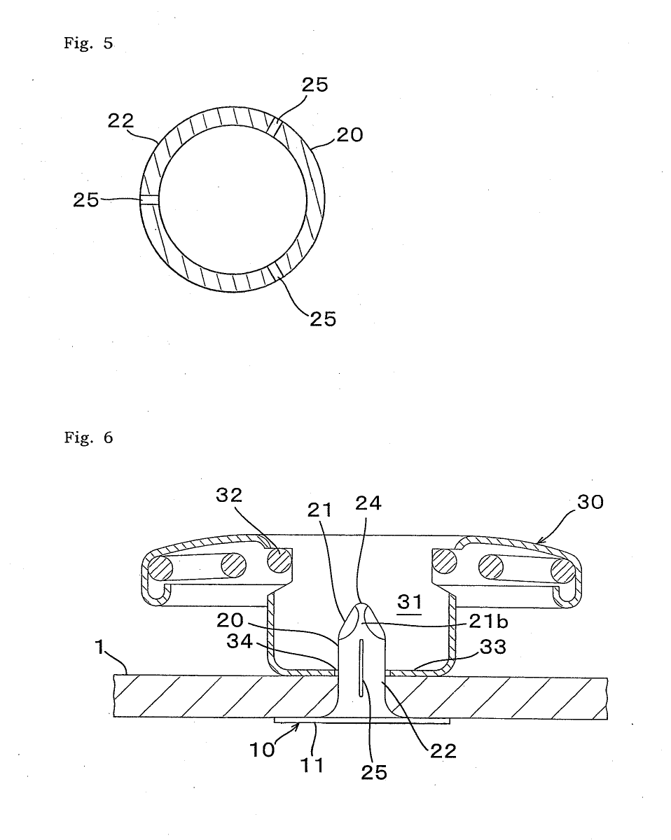

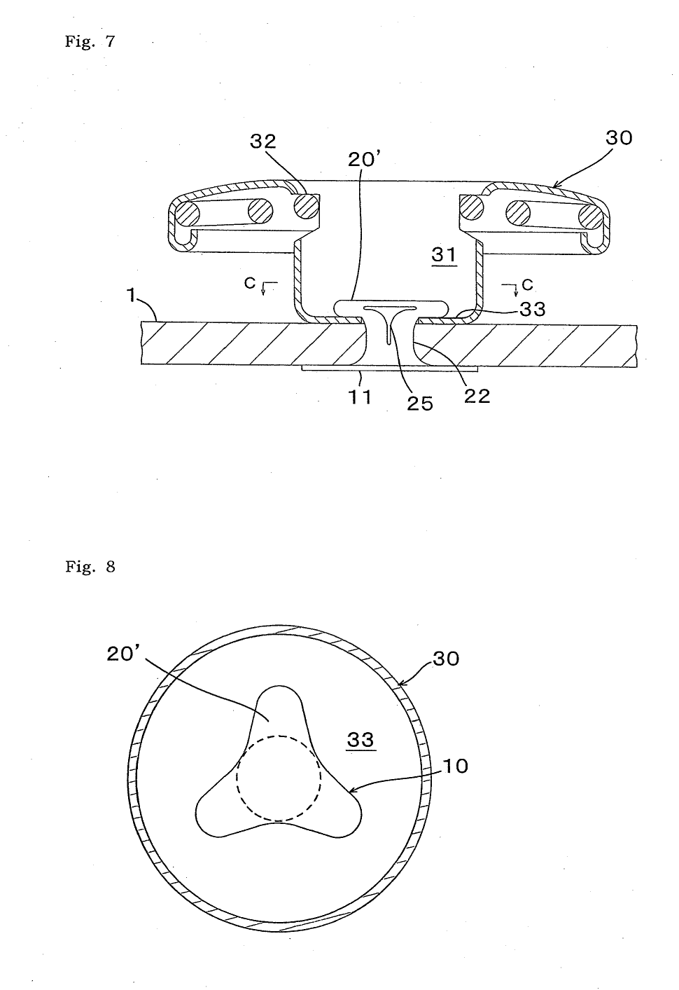

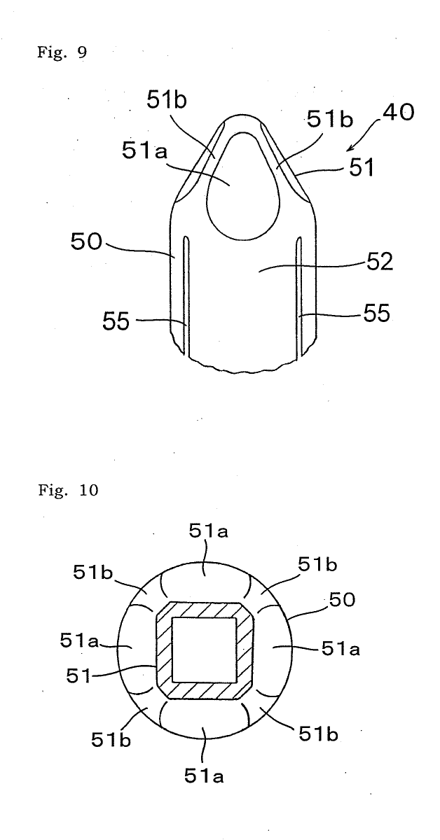

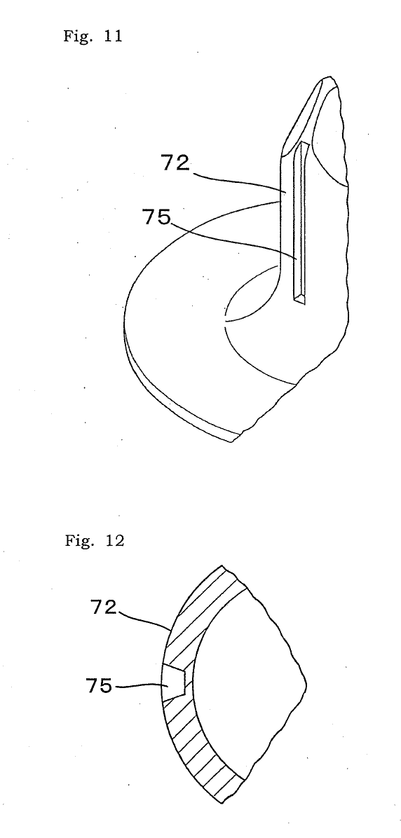

Hereinafter, preferred embodiments of a button-fixing member according to the invention will be described with reference to the drawings. FIG. 1 is a perspective view of a button-fixing member 10 according to an embodiment of the invention. FIGS. 2 and 3 are a plane view (or a top view) and a longitudinal sectional view (along one of after-mentioned slits (dents) 25) of the button-fixing member 10, respectively. FIGS. 4 and 5 are lateral sectional views respectively along line A-A and line B-B of FIG. 3. The button-fixing member 10, which is formed by drawing a single metal plate, includes a disk-like base 11 and a hollow post 20 which is projected upward from and coaxially with the base 11 at its center area. The projecting end 24 of the post 20 is closed. The post 20 includes a triangular pyramid-shaped post top 21 and a cylindrical post barrel 22. The post top 21 has, at its tip, the projecting end 24. The cylindrical post barrel 22 extends between the post top 21 and the base 11. The post barrel 22 includes a post base 23 which rises from the base 11 as its diameter gradually decreases. The portion of the post barrel 22 except the post base 23 is of a cylindrical shape with a constant diameter.

The post top 21 includes three pyramid-element faces 21a, each of which is substantially flat, and three ridge portions 21b between the pyramid-element faces 21a at circumferential intervals of 120 degrees. The pyramid-element faces 21a correspond to the three faces of a triangular pyramid, and three ridge portions 21b correspond to the three ridge lines of the triangular pyramid, but each of the ridge portions 21b is made wider than each of the ridge lines. The ridge portions 21b intersects at the projecting end 24 with each other, and are connected to the post barrel 22 gently compared to the pyramid-element faces 21a as becoming gradually wider downward. Further, the pyramid-element faces 21a are slightly dented with respect to the outer shape of an imaginary cone on the assumption that the post top 21 are formed conically, not like a triangular pyramid, such that the outer shape of the cone includes the ridge portions 21b as they are. Therefore, the ridge portions 21b can function as a shell frame of the post top 21, and when a button is fixed to a cloth with the button-fixing member 10, a force to collapse the post 20 is first received at the projecting end 24 and then transmitted to the post barrel 22 mainly via the ridge portions 21b (not via the pyramid-element faces 21a) as described later in detail. The pyramid-element faces 21a and the ridge portions 21b of the post top 21 are formed by a drawing die at a drawing process.

In the post barrel 22, three slits 25 or dents are formed at the regions circumferentially corresponding to the three ridge portions 21b of the post top 21, or the positions at circumferential intervals of 120 degrees on extension lines of the respective ridge portions 21b. Each of the slits 25 are elongated in the axial direction. The slits 25 penetrate the thickness of the post barrel 22 and extend over the entire length of the cylindrical portion of the post barrel 22 excepting the post base 23. Here, it is also possible to form slits only in an upper half part of the post barrel 22.

Next, with reference to FIGS. 6 to 8, there will be described a process for fixing a female snap 30 as an example of a button to a cloth 1 using the button-fixing member 10 as structured above. The female snap 30 is commonly known product, and includes a recess 31 to detachably engage a projection of a male snap (not illustrated), a spring 32 to strengthen the engagement with the projection of the male snap, and an opening 34 formed at a bottom plate 33 of the recess 31 to pass the post 20 of the button-fixing member 10 which has pierced the cloth 1 into the inside (of the recess 31) of the female snap 30 when the snap 30 is fixed to the cloth 1. Fixing of the female snap 30 to the cloth 1 is performed using a known pressing machine (not illustrated). On this occasion, the button-fixing member 10 is held on an upper die (not illustrated) and the female snap 30 is set on an lower die (not illustrated) with the cloth 1 placed between the member 10 and the snap 30, and then the upper die is lowered coaxially to the lower die. At this time, as shown in FIG. 6, the post 20 of the button-fixing member 10, after piercing the cloth 1 with the projecting end 24 in the lead, enters into the recess 31 through the opening 34 of the female snap 30. At the piercing the cloth 1, since the post top 21 is shaped like a triangular pyramid, the post top 21 can cleave the cloth 1 intensively at the three ridge portions 21b at circumferential intervals of 120 degrees. As compared to a cone-shaped or conical post top, the post top 21 has a better fabric-piercing property and entrains less threads of the cloth 1.

From the state of FIG. 6, the post 20 is pressed downward by the upper die to be compressed in the axial direction as shown in FIG. 7 (the deformed post is indicated by the numeral 20′). As a result, the post 20 is swaged as radially expanding on the bottom plate 33 of the female snap 30. The deformed post 20′ cannot pass through the opening 34, so that the female snap 30 is locked and fixed on the cloth 1. At the time of deforming the post 20, a force arising from the upper die to press the post 20 downward is first received at the projecting end 24 of the post 20 and then transmitted from the post top 21 to the post barrel 22. At this moment, since the ridge portions 21b can function as a shell frame of the post top 21 as mentioned above, the pressing force is transmitted from mainly via the ridge portions 21b to the regions in which the slits 25 are formed in the post barrel 22 directly under each of the ridge portions 21b. The regions including the slits 25 in the post barrel 22 are less rigid in resistance to axial buckling due to the slits 25 than the remaining parts between the two adjacent slit including regions in the circumferential direction, so the slit including regions are tend to more easily collapse axially than the remaining parts. As a result, as shown in FIG. 8, in the deformed post 20′, the regions including the slits 25 at 120 degree intervals extend radially outward larger than the remaining parts. In this way, the post 20 is deformed circumferentially uniformly with the three radially extended regions, so there is less likely to cause the buckling of the post 20 to be circumferentially deviated or biased.

FIG. 9 is a cutaway perspective view of an upper half part of a post 50 of a button-fixing member 40 according to another embodiment of the invention. FIG. 10 is a sectional view of FIG. 9 as similar to FIG. 4. The post 50 includes a quadrangular pyramid-shaped post top 51 and a cylindrical post barrel 52. The post top 51 has four pyramid-element faces 51a and four ridge portions 51b between the pyramid-element faces 51a at circumferential intervals of 90 degrees. Further, in the post barrel 52, four slits 55 are formed at the 90 degree interval regions circumferentially corresponding to the four ridge portions 51b of the post top 51. Each of the slits 55 are elongated in the axial direction. For the button-fixing member 40, when a button is fixed to a cloth with the member 40, the regions including the slits 55 at 90 degree intervals in the post barrel 52 extend larger radially outward.

In the above-described button-fixing member 10, 40, an example to form the slits 25, 55 in the post barrel 22, 52 is shown. However, in the invention, as shown in FIG. 11 and its horizontal section, FIG. 12, grooves 75 or the dents are formed in a post barrel 72 instead of the slits 25, 55. Since the button-fixing member in FIGS. 11 and 12 has the same structure as the button-fixing member 10 in FIG. 1 except for the post barrel 72 with the grooves 75, reference numerals for other portions are omitted in FIGS. 11 and 12. As seen from FIG. 12, the groove 75 is dented from the outer surface of the post barrel 72 without penetrating the thickness of the post barrel 72. With the grooves 75, it is possible to make the post barrel 72 less rigid partially in resistance to axial buckling so that, when a button is fixed to a cloth, the regions including the grooves 75 extend larger radially outward as with the post barrel 22 with the slits 25.
1 cloth (sheet material)
10, 40 button-fixing member
11 base
20, 20′, 50 post
21, 51 post top
21a, 51a pyramid-element face
21b, 51b ridge portion
22, 52, 72 post barrel
24 projecting end
25, 55 slit (dent)
30 female snap
75 groove

1. A button-fixing member including a base and a post which projects from the base, for fixing a button to a sheet material by swaging the post to lock the button after the post has pierced the sheet material with the projecting end of the post in the lead,
wherein the post is hollow and includes a triangular pyramid-shaped or quadrangular pyramid-shaped post top which defines the projecting end and a cylindrical post barrel which extends between the post top and the base;
wherein the post top includes three or four pyramid-element faces and three or four ridge portions between the pyramid-element faces; and
wherein the post barrel includes dents which are elongated in the axial direction of the post at the positions in the circumferential direction of the post corresponding to the ridge portions.

2. The button-fixing member according to claim 1, wherein the dents are slits which penetrate the thickness of the post barrel.

3. The button-fixing member according to claim 1 being formed by drawing a single metal plate.
